(19) United States
(12) Patent Application Publication
(10) Pub. No.: US 2014/0113050 A1
(43) Pub. Date: Apr. 24, 2014

(54) UNFERMENTED BEER-FLAVOURED BEVERAGE AND MANUFACTURING METHOD THEREFOR

(71) Applicants: Shinsuke Ito, Moriya-shi (JP); Jun Kubota, Moriya-shi (JP)

(72) Inventors: Shinsuke Ito, Moriya-shi (JP); Jun Kubota, Moriya-shi (JP)

(73) Assignee: ASAHI BREWERIES, LTD., Sumida-ku, Tokyo (JP)

(21) Appl. No.: 14/124,941

(22) PCT Filed: Dec. 1, 2011
(86) PCT No.: PCT/JP2011/077785

§ 371 Date: Dec. 9, 2013

(51) Int. Cl. C12C 5/02

(52) U.S. Cl. CPC C12C 5/026
USPC 426/548; 426/592; 426/598; 426/590

(57) ABSTRACT

An object of the invention is to impart a taste like beer to a non-fermented beer taste drink. Means for achieving the object is a method for production of a non-fermented beer taste drink, comprising a step of including in drinking water 8 mg/ml or more of a polymeric saccharide and 0.008 to 100 parts by weight of a sweet-taste substance based on 100 parts by weight of the polymeric saccharide.

### TECHNICAL FIELD

The present invention relates to a non-fermented beer taste drink, and particularly to a non-fermented alcoholic beer taste drink and a non-fermented carbonated beer taste drink.

### BACKGROUND ART

Beer taste drinks include various kinds of products such as alcoholic beer taste drinks which are alcoholic drinks substantially containing ethanol, carbonated beer taste drinks which are carbonated drinks substantially not containing ethanol, and the like.

The alcoholic beer taste drink is produced principally by fermenting a saccharified liquid of malt or cereals as a main raw material. An alcoholic beer taste drink produced through a fermentation step will be hereinafter referred to as a “fermented alcoholic beer taste drink”. On the other hand, alcoholic beer taste drinks also include those produced by adding wort, a malt extract, a saccharide, a flavor, ethanol and the like to drinking water so as to have a taste and a taste quality like beer. An alcoholic beer taste drink produced without a fermentation step will be hereinafter referred to as a “non-fermented alcoholic beer taste drink”.

The non-fermented alcoholic beer taste drink does not require a special fermentation apparatus for production because a production process does not include fermentation. Therefore, they are suitable for mass production at low costs. However, it has not been clarified yet what amounts and what kinds of components can be mixed to reproduce a taste and a taste quality like beer, and a production method is still under research and development.

On the other hand, carbonated beer taste drinks have a low alcohol level, and can be casually drunk by drivers and pregnant and lactating women. Generally, carbonated beer taste drinks have a low calorie in comparison with normal beer, and are thus favored by health-conscious people.

Methods for producing carbonated beer taste drinks are classified broadly into three types: (1) removal of ethanol, (2) control of fermentation and (3) non-fermentation. In method (1), only an ethanol component is removed from normal beer by a special apparatus to prepare the carbonated drink. In method (2), activity of yeasts is controlled by, for example, fermentation at a temperature lower than is normal, so that the ethanol content becomes low. A carbonated beer taste drink produced through the fermentation step will be hereinafter referred to as a “fermented carbonated beer taste drink”.

The fermented carbonated beer taste drink has a taste like beer because a production method includes a fermentation step. However, ethanol is generated in the fermentation step, and it is difficult to fully eliminate the ethanol content.

In contrast, in method (3), wort, a malt extract, a saccharide, a flavor and the like are added to drinking water to produce the carbonated drink. The carbonated beer taste drink produced without the fermentation step will be hereinafter referred to as a “non-fermented carbonated beer taste drink”. The non-fermented carbonated beer taste drink is easily made to contain no ethanol because a production process does not include fermentation. Further, no special fermentation apparatus is required for production. Therefore, such drinks are suitable for mass production at low costs, and are low-price drinks suiting all tastes. However, it has not been clarified yet what amounts and what kinds of components can be mixed to reproduce a taste and a taste quality like beer, and a production method is still under research and development.

The non-fermented alcoholic beer taste drink can be produced by adding a predetermined amount of ethanol in a process of producing a non-fermented carbonated beer taste drink. In other words, an essential difference between the former and the latter lies only in whether ethanol is contained or not. Therefore, in the present description, the non-fermented alcoholic beer taste drink and the non-fermented carbonated beer taste drink are dealt with together, and both the drinks are referred to collectively as a “non-fermented beer taste drink”.

Patent Document 1 describes that in a step of producing a non-fermented carbonated beer taste drink, use of a vegetable protein decomposition product and a malt extract as raw materials can impart beer-like bitterness and a rich taste (body), and add profoundness and coordination to a flavor and a taste.

Patent Document 2 describes that a DE 6 to 30 starch decomposition product is useful for improving taste qualities such as a creamy property and a rich taste of a carbonated drink.

However, there is a problem that non-fermented beer taste drinks are still greatly different in taste like beer when compared to normal beer, and are particularly inferior to normal beer in “drink fulfillment and stimulation to a throat” and “satisfactory sharpness after drinking”.

In the fields of fermented alcoholic beer taste drinks, methods for enhancing drink fulfillment and sharpness after drinking are known. For example, Patent Document 3 describes that drink fulfillment can be secured by having a high use ratio of malt in a raw material, and that sharpness of feeling of drink going down the throat can be imparted without impairing drink fulfillment of a malt fermented drink by adding a distilled liquid obtained by distilling an alcohol-containing substance with wheat as one of raw materials.

### BACKGROUND ART DOCUMENTS

### Patent Documents

[Patent Document 1] Japanese Patent Laid-open Publication No. 2011-142901
[Patent Document 2] Japanese Patent Laid-open Publication No. 2002-330735
[Patent Document 3] International Publication No. WO 2005/056746

### SUMMARY OF THE INVENTION

### Problems to be Solved by the Invention

The present invention solves the above-mentioned conventional problems, and an object thereof is to impart a taste like beer to a non-fermented beer taste drink. More specifically, a taste like beer is imparted to a non-fermented beer taste drink by enhancing and appropriately balancing “drink fulfillment and stimulation to a throat” and “satisfactory sharpness after drinking” in the non-fermented beer taste drink.

### Means for Solving the Problems

The present invention provides a method for production of a non-fermented beer taste drink, comprising a step of including in drinking water 8 mg/ml or more of a polymeric saccharide and 0.008 to 100 parts by weight of a sweet-taste substance based on 100 parts by weight of the polymeric saccharide.

In one embodiment, the polymeric saccharide is a starch decomposition product having a DE of 5 to 24.

In one embodiment, the sweet-taste substance is at least one saccharide selected from the group consisting of a monosaccharide, a disaccharide and a trisaccharide.

In one embodiment, the method for production of a non-fermented beer taste drink does not comprise a step of including wort or a barley extract.

In one embodiment, the method for production of a non-fermented beer taste drink further comprises a step of including a cereal-derived protein decomposition product.

The present invention also provides a non-fermented beer taste drink produced by any one of the aforementioned methods.

The present invention also provides a non-fermented beer taste drink, which contains 8 mg/ml or more of a polymeric saccharide and 0.008 to 100 parts by weight of a sweet-taste substance based on 100 parts by weight of the polymeric saccharide.

In one embodiment, the polymeric saccharide is a starch decomposition product having a DE of 5 to 24.

In one embodiment, the sweet-taste substance is at least one saccharide selected from the group consisting of a monosaccharide, a disaccharide and a trisaccharide.

In one embodiment, the non-fermented beer taste drink does not contain wort or a barley extract.

In one embodiment, the non-fermented beer taste drink further contains a cereal-derived protein decomposition product.

### Effect of the Invention

A non-fermented beer taste drink according to the present invention has enhanced and appropriately balanced “drink fulfillment and stimulation to a throat” and “satisfactory sharpness after drinking”, and has a taste like beer.

### EMBODIMENT FOR CARRYING OUT THE INVENTION

A non-fermented beer taste drink according to the present invention contains a polymeric saccharide. By containing the polymeric saccharide, the resulting drink gives a sense of striking the throat when drunk, so that “drink fulfillment and stimulation to a throat” is exhibited.

The polymeric saccharide refers to a polymer compound with various kinds of saccharides polymerized by a glycoside linkage. The polymeric saccharide is preferably a non-fermenting saccharide. Examples of the polymeric saccharide include starch decomposition products such as a dextrin and an indigestible dextrin. Among them, the preferably polymeric saccharide is a starch decomposition product from the viewpoint of effectiveness. If the polymeric saccharide has too small a molecular weight, the sense of striking the throat in the non-fermented beer taste drink decreases, thus being not preferable, and if the polymeric saccharide has too large a molecular weight, it is hard to dissolve in drinking water used for a raw material, thus being not preferable.

The starch decomposition product refers collectively to products obtained by decomposing starch to have an appropriate molecular weight using an enzyme and/or an acid. Examples of the starch decomposition product include a dextrin obtained by dispersing starch in water, adding thereto an enzyme (e.g. alpha-amylase) and/or an acid (e.g. hydrochloric acid or oxalic acid), heating the resulting mixture to gelatinize, and hydrolyzing the same, and an indigestible dextrin obtained by acting an enzyme such as alpha-amylase on a dextrin obtained by acid roasting of starch, and the starch decomposition product can be subjected to refinement such as decoloring and deionization as necessary, formed into a liquid or formed into a powder by spray-drying, drum-drying or the like, and used. In addition, reduced starch hydrolysates obtained by hydrogenating the above-mentioned starch decomposition products are similarly effective, and are therefore included.

Among these starch decomposition products, those having a DE of 5 to 24 are suitable when considering a sense of striking the throat in the non-fermented beer taste drink. If DE is less than 5, the starch decomposition product has poor solubility, and a phenomenon such as white turbidity occurs during storage of the non-fermented beer taste drink, leading to deterioration of outer appearance. If DE is more than 24, the sense of striking the throat in the non-fermented beer taste drink is weak, and balance of the taste is deteriorated. DE of the starch decomposition product is preferably 10 to 20, more preferably 13 to 17.

The amount of the polymeric saccharide contained in the non-fermented beer taste drink according to the present invention is about 8 mg/ml or more in terms of concentration. If the concentration of the polymeric saccharide is less than about 8 mg/ml, the sense of striking the throat in the non-fermented beer taste drink becomes weak. The concentration of the polymeric saccharide is preferably 12 to 50 mg/ml, more preferably 16 to 32 mg/ml. If the concentration of the polymeric saccharide is more than 50 mg/ml, the taste of the non-fermented beer taste drink may be degraded.

The non-fermented beer taste drink according to the present invention contains a sweet-taste substance. The sweet-taste substance refers to a substance causing a person to feel sweet when it is held in his or her mouth. A typical sweet-taste substance is a sweetener. The sweetener refers to a seasoning that is used for adding a sweet taste to drinks or foods. By containing the sweet-taste substance, the resulting drink is well balanced between a sour taste and a sweet taste, and becomes hard to give an aftertaste of the sour taste, the sweet taste or the like, so that “satisfactory sharpness after drinking” is exhibited.

Examples of the sweet-taste substance include saccharides or sugar alcohols, and High Intensity Sweeteners. Examples of the saccharide include glucose, fructose, wood sugar, sorbose, galactose, isomerized sugars (fructose-glucose syrup, glucose-fructose syrup, high-fructose syrup, etc.), sucrose, maltose, lactose, isomerized lactoses, palatinose, isomaltose, maltotriose, raffinose, fructo-oligosaccharides, malto-oligosaccharides, isomalto-oligosaccharides, galacto-oligosaccharides, coupling sugars, palatinose and the like. Examples of the sugar alcohol include erythritol, sorbitol, xylitol, mannitol, maltitol, isomaltitol, lactitol, maltotriitol, isomaltotriitol, panitol and the like. Examples of the High Intensity Sweeteners include aspartame, stevia, enzyme-treated stevia, thaumatin, sucralose and acesulfame K.

The sweet-taste substance is preferably a low-molecular-weight saccharide. The low-molecular-weight saccharide refers to an oligomer with various kinds of saccharides linked by a glycoside linkage. A more preferable sweet-taste substance is at least one selected from the group consisting of a monosaccharide, a disaccharide and a trisaccharide. A further preferable sweet-taste substance is at least one selected from the group consisting of glucose, fructose, maltose, fructose-glucose and glucose-fructose.

The amount of the sweet-taste substance contained in the non-fermented beer taste drink according to the present invention is appropriately adjusted within a range of 0.008 to 100 parts by weight based on 100 parts by weight of the polymeric saccharide. If the content of the sweet-taste substance in the non-fermented beer taste drink is less than 0.008 parts by weight based on 100 parts by weight of the polymeric saccharide, the non-fermented beer taste drink easily gives an aftertaste of a sour taste and the like, thus being not preferable. If the content of the sweet-taste substance is more than 100 parts by weight based on 100 parts by weight of the polymeric saccharide, a sweet taste tends to remain as an aftertaste, thus being not preferable.

The concentration of the sweet-taste substance contained in the non-fermented beer taste drink is appropriately adjusted to be 1 to 18 mg/ml in terms of sucrose.

For example, the content of the sweet-taste substance is adjusted in consideration of the amount of ethanol contained in the non-fermented beer taste drink. This is because ethanol also has a sweet taste as a taste exhibiting function. The form of ethanol added is not limited, and for example, material alcohol, beer, shochu, awamori, whisky, brandy, vodka, rum, tequila, gin, spirits and so on can be added.

When the non-fermented beer taste drink is a non-fermented beer taste drink which substantially does not contain ethanol, the content of the sweet-taste substance is 0.008 to 100 parts by weight, preferably 10 to 100 parts by weight, more preferably 20 to 80 parts by weight, further preferably 30 to 65 parts by weight, based on 100 parts by weight of the polymeric saccharide.

In this case, the concentration of the sweet-taste substance contained in the non-fermented beer taste drink is 1 to 18 mg/ml, preferably 4 to 13 mg/ml, more preferably 6 to 11 mg/ml, in terms of sucrose.

When the non-fermented beer taste drink is a non-fermented alcoholic beer taste drink which substantially contains ethanol, the content of the sweet-taste substance is 0.008 to 100 parts by weight, preferably 1 to 10 parts by weight, more preferably 2 to 8 parts by weight, further preferably 3 to 6.5 parts by weight, based on 100 parts by weight of the polymeric saccharide, when the alcohol level is, for example, 1 to 10 degrees.

In this case, the concentration of the sweet-taste substance contained in the non-fermented beer taste drink is 0.1 to 1.8 mg/ml, preferably 0.4 to 1.3 mg/ml, more preferably 0.6 to 1.1 mg/ml, in terms of sucrose.

The non-fermented beer taste drink according to the present invention preferably contains a cereal-derived protein decomposition product. By containing the cereal-derived protein decomposition product, the sense of striking the throat when the non-fermented beer taste drink is drunk, namely “drink fulfillment and stimulation to a throat” is further enhanced.

The cereal-derived protein decomposition product is a product obtained by hydrolyzing a cereal protein raw material by an acid, an alkali or an enzyme, wherein the cereal protein raw material is a vegetable protein raw material which is a fraction obtained from soybean, pea, corn, wheat, barley, rice, peanut, rapeseed, sunflower and the like and contains a protein such as a separated protein in a large amount. The cereal-derived protein raw material is preferably a protein derived from legume such as soybean and pea, and the hydrolysis method is preferably an enzymic method. The enzymic method uses one or more proteases to carry out hydrolysis using their suitable temperature, pH and time. The degree of decomposition can be appropriately adjusted, but generally a 15 wt % TCA solubilization rate of 30 to 100% is suitable. If the molecule size is too large, a large amount of fraction insolubilizes in the form of sediments in a post-process or during storage, and if the molecule size is too small, a discomfort umami taste is easily caused. Accordingly, a suitable average molecular weight of a water-soluble fraction contained in the cereal-derived protein decomposition product is 550 or more and 3000 or less, preferably 600 or more and 1500 or less.

The meanings of the 15 wt % TCA solubilization rate and average molecular weight of a water-soluble fraction that are parameters of the cereal-derived protein decomposition product are as described, respectively, in paragraphs [0017] and [0018] of Patent Document 1.

If the amount of the cereal-derived protein decomposition product contained in the non-fermented beer taste drink according to the present invention is too small, its effect is low, and if the amount is too large, conversely an unpleasant taste is easily caused, and further a risk of microbiological contamination may be caused due to a rise in pH. Generally, the cereal-derived protein decomposition product is used in such an amount that the concentration in the final drink is 10 mg/ml or less, preferably 0.1 to 6 mg/ml, more preferably 0.5 to 4 mg/ml.

Preferably, the non-fermented beer taste drink according to the present invention does not contain wort or a barley extract. The wort refers to a liquid obtained by crushing and saccharifying barley malt. The barley extract refers to an extract liquid with a component extracted from barley, barley malt or a crushed product thereof with water or hot water, or a concentrated product or a dried product of the extract liquid. The wort or barley extract contains a relatively low-molecular-weight saccharide or nitrogen source in a large amount, and has a strong sweet taste or umami taste as such. Therefore, if the wort or barley extract is included in the non-fermented beer taste drink, tastes are hard to be balanced, so that a sweet taste remains as an aftertaste and an unpleasant odor is easily generated.

Essentially, in a yeast-fermented beer taste drink, a low-molecular-weight saccharide or nitrogen source is assimilated by the yeast, and hardly contained in the final product. In contrast, a high-molecular weight saccharide is not assimilated by the yeast, and therefore remains as it is in the final product. It is believed that in the fermented beer taste drink, balance of contents between only a small amount of a low-molecular-weight saccharide (sweet-taste substance) and a large amount of a high-molecular weight saccharide suppresses an excessive aftertaste such as an excessive sweet taste or umami taste to provide drink fulfillment and stimulation to a throat, so that a taste like beer is achieved.

The non-fermented beer taste drink according to the present invention preferably contains a hop or a hop extract in order to reproduce a fresh bitter taste characteristic of beer. The hop or hop extract refers to hop leaves or a ground product thereof, an extract liquid with the hop leaves or ground product thereof extracted with water or hot water, or a concentrated product or a dried product of the extract liquid. The added amount of the hop or hop extract is such an amount that a taste originating from the hop is provided, and can be, for example, generally 0.005 to 2 wt %, preferably 0.01 to 0.5 wt % in terms of a raw material hop (dried product) for each final drink.

In addition, for the non-fermented beer taste drink according to the present invention, raw materials such as a saccharide, a sugar alcohol, various kinds of glucosides such as saponin, a flavor, dietary fiber and a polysaccaharide, an acid and a yeast extract can be used at the same time as long as the object of the present invention is not impaired. Examples of the saccharide include reducing sugars such as glucose, fructose and maltose, oligosaccharides such as sucrose, and various kinds of dextrins and oligosaccharides, and examples of the flavor may include a malt flavor, a hop flavor, a beer flavor, an alcohol flavor, a caramel flavor and the like. Examples of the acid may include organic acids such as citric acid, lactic acid and tartaric acid, and mineral acids such as hydrochloric acid and phosphoric acid.

A method for production of a non-fermented beer taste drink according to the present invention includes steps that are normally carried out when a non-fermented beer taste drink is produced. As one example, a polymeric saccharide, a sweet-taste substance and other components are first mixed in predetermined amounts to prepare a formulation. Then, to the formulation is added drinking water in a predetermined amount to prepare a primary raw material liquid. The primary raw material liquid is boiled, a fermented alcohol is then added as necessary, and carbonic acid is added by a carbonation step.

It is also possible to separate and remove precipitates by filtration, centrifugal separation or the like in each stage as necessary. Also, carbonated water may be added after the raw material liquid is prepared in a concentrated state. In these steps, a non-fermented beer taste drink can be conveniently prepared by using a normal process for production of a soft drink without necessity of fermentation equipment.

Removal of precipitates before the carbonation step and the carbonated water adding step is desirable because sediments and substances causing an unpleasant taste can be removed. Filtration or sterilization may be performed as necessary before the carbonation step and the carbonated water adding step.

The present invention will be described more specifically with reference to the following examples, but the present invention is not limited thereto.

### EXAMPLES

### Example 1

### Production of Non-Fermented Carbonated Beer Taste Drink

A dextrin of DE 14 (“Liquid Dextrin” manufactured by Matsutani Chemical Industry Co., Ltd.) as a polymeric saccharide, maltose (“MR 70” manufactured by Showa Sangyo Co., Ltd.) as a sweet-taste substance, a soybean peptide as a soybean protein decomposition product and so on were prepared as formulation ingredients.

The formulation ingredients listed in Table 1 were mixed in amounts (g) shown by numerical values, and water was added to the resulting formulation up to a total volume of 1 L to prepare a primary raw material liquid, and the liquid was boiled for an hour. The primary raw material liquid was cooled, water was then added in an amount equal to the amount of evaporated water, and diatomaceous earth filtration and filter filtration were performed for clarification. A carbon dioxide gas was then blown into the liquid, so that the carbon dioxide gas was dissolved in a gas volume of 2.9 to obtain a non-fermented carbonated beer taste drink.

TABLE 1

| Formulation | Control | Control | Experimental | Experimental | Experimental | Experimental |
|---|---|---|---|---|---|---|
| ingredient | plot 1 | plot 2 | plot 1 | plot 2 | plot 3 | plot 4 |
| Polymeric | 0.0 | 2.0 | 10.0 | 16.0 | 24.0 | 32.0 |
| saccharide (DE 14) | | | | | | |
| Sweet-taste | 10.0 | 10.0 | 10.0 | 10.0 | 10.0 | 10.0 |
| substance (maltose) | | | | | | |
| Soybean protein | 2.0 | 2.0 | 2.0 | 2.0 | 2.0 | 2.0 |
| decomposition | | | | | | |
| product | | | | | | |
| Caramel | 0.3 | 0.3 | 0.3 | 0.3 | 0.3 | 0.3 |
| Hop extract | 0.2 | 0.2 | 0.2 | 0.2 | 0.2 | 0.2 |
| Phosphoric acid | 0.7 | 0.7 | 0.7 | 0.7 | 0.7 | 0.7 |

A sensory evaluation was made for the obtained non-fermented carbonated beer taste drink. The sensory evaluation was conducted with a nose clip attached to the nose in order to avoid influences by an aroma. For the evaluation, scores on a scale of 9 marked by 13 beer expert panelists, respectively, were averaged. The results are shown in Table 2.

TABLE 2

| | Control | Control | Experimental | Experimental | Experimental | Experimental | Control |
|---|---|---|---|---|---|---|---|
| | plot 1 | plot 2 | plot 1 | plot 2 | plot 3 | plot 4 | plot 3* |
| Drink | 4.1 | 4.6 | 5.5 | 6.3 | 6.7 | 6.9 | 6.9 |
| fulfillment and | | | | | | | |
| stimulation to | | | | | | | |
| a throat | | | | | | | |
| Satisfactory | 5.4 | 5.7 | 6.3 | 6.7 | 6.9 | 6.7 | 7.1 |
| sharpness | | | | | | | |
| after drinking | | | | | | | |
| Taste like beer | 3.8 | 4.1 | 5.1 | 6.3 | 6.8 | 6.7 | 7.1 |

*Control plot 3 was evaluated with beer of our company as a sample.

Control plots 1 and 2 received very low rates in comparison with control plot 3 of beer of our company for “drink fulfillment and stimulation to a throat” and “taste like beer”, whereas for experimental plots, it was confirmed that as the amount of the polymeric saccharide increased, rates of “drink fulfillment and stimulation to a throat” and “taste like beer” were improved.

### Example 2

### Production of Non-Fermented Alcoholic Beer Taste Drink

Formulation ingredients same as those used in Example 1 were prepared.

The formulation ingredients listed in Table 3 were mixed in amounts (g) shown by numerical values, and water was added to the resulting formulation up to a total volume of 0.95 L to prepare a primary raw material liquid, and the liquid was boiled for an hour. The primary raw material liquid was cooled, water was then added in an amount equal to the amount of evaporated water, a raw material alcohol of 95 degrees or more was further added in an amount equal to 0.05 L, and diatomaceous earth filtration and filter filtration were performed for clarification. A carbon dioxide gas was then blown into the liquid, so that the carbon dioxide gas was dissolved in a gas volume of 2.9 to obtain a non-fermented alcoholic beer taste drink.

TABLE 3

| | Control | Control | Experimental | Experimental | Experimental | Experimental |
|---|---|---|---|---|---|---|
| | plot 4 | plot 5 | plot 5 | plot 6 | plot 7 | plot 8 |
| Polymeric saccharide | 0.0 | 2.0 | 8.0 | 16.0 | 24.0 | 32.0 |
| (DE 14) | | | | | | |
| Sweet-taste substance | 1.0 | 1.0 | 1.0 | 1.0 | 1.0 | 1.0 |
| (maltose) | | | | | | |
| Soybean protein | 2.0 | 2.0 | 2.0 | 2.0 | 2.0 | 2.0 |
| decomposition product | | | | | | |
| Caramel | 0.3 | 0.3 | 0.3 | 0.3 | 0.3 | 0.3 |
| Hop extract | 0.2 | 0.2 | 0.2 | 0.2 | 0.2 | 0.2 |
| Phosphoric acid | 0.7 | 0.7 | 0.7 | 0.7 | 0.7 | 0.7 |

A sensory evaluation was made for the obtained non-fermented alcoholic beer taste drink. The sensory evaluation was conducted with a nose clip attached to the nose in order to avoid influences by an aroma. For the evaluation, scores on a scale of 9 marked by 13 beer expert panelists, respectively, were averaged. The results are shown in Table 4.

TABLE 4

| | Control | Control | Experimental | Experimental | Experimental | Experimental | Control |
|---|---|---|---|---|---|---|---|
| | plot 4 | plot 5 | plot 5 | plot 6 | plot 7 | plot 8 | plot 6* |
| Drink fulfillment | 4.9 | 4.8 | 5.8 | 6.7 | 6.9 | 7.1 | 7.0 |
| and stimulation to | | | | | | | |
| a throat | | | | | | | |
| Satisfactory | 5.8 | 6.1 | 6.4 | 6.8 | 7.1 | 6.7 | 7.2 |
| sharpness after | | | | | | | |
| drinking | | | | | | | |
| Taste like beer | 4.4 | 4.4 | 5.4 | 6.5 | 7.0 | 6.8 | 7.3 |

*Control plot 6 was evaluated with beer of our company as a sample.

Control plots 4 and 5 received very low rates in comparison with control plot 6 of beer of our company for “drink fulfillment and stimulation to a throat” and “taste like beer”, whereas for experimental plots, it was confirmed that as the amount of the polymeric saccharide increased, rates of “drink fulfillment and stimulation to a throat” and “taste like beer” were improved.

### Example 3

### Effect by Type of Polymeric Saccharide

A dextrin of DE 25 (“Pinedex #3” manufactured by Matsutani Chemical Industry Co., Ltd.), a dextrin of DE 20 (“LDX 35-20” manufactured by Showa Sangyo Co., Ltd.), a dextrin of DE 15 (“Glister” manufactured by Matsutani Chemical Industry Co., Ltd.), a dextrin of DE 14 (“Liquid Dextrin” manufactured by Matsutani Chemical Industry Co., Ltd.), a dextrin of DE 11 (“Pinedex #2” manufactured by Matsutani Chemical Industry Co., Ltd.), an indigestible dextrin of DE 11 (“Fibersol 2” manufactured by Matsutani Chemical Industry Co., Ltd.) and a dextrin of DE 4 (“Pinedex #100” manufactured by Matsutani Chemical Industry Co., Ltd.) as polymeric saccharides, maltose (“MR 70” manufactured by Showa Sangyo Co., Ltd.) as a sweet-taste substance, a soybean peptide as a soybean protein decomposition product and so on were prepared as formulation ingredients.

The formulation ingredients listed in Table 5 were mixed in amounts (g) shown by numerical values, and water was added to the resulting formulation up to a total volume of 1 L to prepare a primary raw material liquid, and the liquid was boiled for an hour. The primary raw material liquid was cooled, water was then added in an amount equal to the amount of evaporated water, and diatomaceous earth filtration and filter filtration were performed for clarification. A carbon dioxide gas was then blown into the liquid, so that the carbon dioxide gas was dissolved in a gas volume of 2.9 to obtain a non-fermented carbonated beer taste drink.

TABLE 5

| | Control | Experimental | Experimental | Experimental | Experimental | Experimental | Control |
|---|---|---|---|---|---|---|---|
| | plot 7 | plot 9 | plot 10 | plot 11 | plot 12 | plot 13 | plot 8 |
| Type of | DE 25 | DE 20 | De 15 | DE 14 | DE 11 | DE 11 | DE 4 |
| polymeric | Dextrin | Dextrin | Dextrin | Dextrin | Dextrin | Indigestible | Dextrin |
| saccharide | 24 | 24 | 24 | 24 | 24 | dextrin | 24 |
| | | | | | | 24 | |
| Sweet-taste | 10 | 10 | 10 | 10 | 10 | 10 | 10 |
| substance | | | | | | | |
| (maltose) | | | | | | | |
| Soybean | 2.0 | 2.0 | 2.0 | 2.0 | 2.0 | 2.0 | 2.0 |
| protein | | | | | | | |
| decomposition | | | | | | | |
| product | | | | | | | |
| Caramel | 0.3 | 0.3 | 0.3 | 0.3 | 0.3 | 0.3 | 0.3 |
| Hop extract | 0.2 | 0.2 | 0.2 | 0.2 | 0.2 | 0.2 | 0.2 |
| Phosphoric | 0.7 | 0.7 | 0.7 | 0.7 | 0.7 | 0.7 | 0.7 |
| acid | | | | | | | |

A sensory evaluation was made for the obtained non-fermented carbonated beer taste drink. The sensory evaluation was conducted with a nose clip attached to the nose in order to avoid influences by an aroma. For the evaluation, scores on a scale of 9 marked by 5 beer expert panelists, respectively, were averaged. The results are shown in Table 6.

TABLE 6

| | Control | Experimental | Experimental | Experimental | Experimental | Experimental | Control |
|---|---|---|---|---|---|---|---|
| | plot 7 | plot 9 | plot 10 | plot 11 | plot 12 | plot 13 | plot 8 |
| Drink | 4.8 | 5.8 | 6.4 | 6.8 | 7.2 | 7.2 | 7.2 |
| fulfillment | | | | | | | |
| and | | | | | | | |
| stimulation | | | | | | | |
| to a throat | | | | | | | |
| Satisfactory | 3.8 | 5.6 | 7.2 | 7.0 | 7.2 | 7.0 | 5.4 |
| sharpness | | | | | | | |
| after | | | | | | | |
| drinking | | | | | | | |
| Taste like | 4.4 | 5.8 | 6.8 | 7.0 | 7.4 | 7.2 | 6.4 |
| beer | | | | | | | |
| Solubility | ∘ | ∘ | ∘ | ∘ | ∘ | ∘ | x |

Control plot 7 received low rates for “drink fulfillment and stimulation to a throat”, “satisfactory sharpness after drinking” and “taste like beer”, whereas for experimental plots, it was confirmed that as DE decreased, rates of “drink fulfillment and stimulation to a throat”, “satisfactory sharpness after drinking” and “taste like beer” were improved for both the dextrin and the indigestible dextrin. On the other hand, for the dextrin of DE 4, solubility was very poor, and it was considered that use of a saccharide having this level of decomposition degree is not practical when considering production efficiency.

### Example 4

### Effect by Type of Sweet-Taste Substance and Formulation of Sweetener

A dextrin of DE 14 (“Liquid Dextrin” manufactured by Matsutani Chemical Industry Co., Ltd.) as a polymeric saccharide, glucose (“Liquid Glucose” manufactured by Nihon Shokuhin Kako Co., Ltd.), fructose (“Fujifruct L-95” manufactured by Nihon Shokuhin Kako Co., Ltd.), maltose (“MR 70” manufactured by Showa Sangyo Co., Ltd.), maltotriose (“Puretose L” manufactured by Gun Ei Chemical Industry Co., Ltd.), sucrose (“S67F” manufactured by NISSIN CUP CO., LTD.), fructose-glucose (“NF 55” manufactured by Showa Sangyo Co., Ltd.), acesulfame potassium (“Sannet” manufactured by Kirin Kyowa Foods Company, Limited), sucralose (“Sucralose” manufactured by San-Ei Gen F.F.I., Inc.), stevia (“Rebaudio” manufactured by Morita Kagaku Kogyo Co., Ltd.), aspartame (“PAL SWEET” manufactured by Ajinomoto Co., Inc.) and thaumatin (“Sunsweet” manufactured by San-Ei Gen F.F.I., Inc.) as sweet-taste substances, a soybean peptide as a soybean protein decomposition product and so on were prepared as formulation ingredients.

The formulation ingredients listed in Table 7 were mixed in amounts (g) shown by numerical values, and water was added to the resulting formulation up to a total volume of 1 L to prepare a primary raw material liquid, and the liquid was boiled for an hour. The primary raw material liquid was cooled, water was then added in an amount equal to the amount of evaporated water, and diatomaceous earth filtration and filter filtration were performed for clarification. A carbon dioxide gas was then blown into the liquid, so that the carbon dioxide gas was dissolved in a gas volume of 2.9 to obtain a non-fermented carbonated beer taste drink.

TABLE 7-1

| | Control | Experimental | Experimental | Experimental | Experimental | Experimental |
|---|---|---|---|---|---|---|
| | plot 9 | plot 14-1 | plot 14-2 | plot 14-3 | plot 14-4 | plot 14-5 |
| Polymeric | 24 | 24 | 24 | 24 | 24 | 24 |
| saccharide (DE 14) | | | | | | |
| Sweet-taste | 0 | Glucose | Fructose | Maltose | Maltotriose | Sucrose |
| substance | | 8.0 | 4.0 | 12 | 17.0 | 5.0 |
| Soybean protein | 2.0 | 2.0 | 2.0 | 2.0 | 2.0 | 2.0 |
| decomposition | | | | | | |
| product | | | | | | |
| Caramel | 0.3 | 0.3 | 0.3 | 0.3 | 0.3 | 0.3 |
| Hop extract | 0.2 | 0.2 | 0.2 | 0.2 | 0.2 | 0.2 |
| Phosphoric acid | 0.7 | 0.7 | 0.7 | 0.7 | 0.7 | 0.7 |

TABLE 7-2

| | Experimental | Experimental | Experimental | Experimental | Experimental | Experimental |
|---|---|---|---|---|---|---|
| | plot 14-6 | plot 14-7 | plot 14-8 | plot 14-9 | plot 14-10 | plot 14-11 |
| Polymeric | 24 | 24 | 24 | 24 | 24 | 24 |
| saccharide | | | | | | |
| (DE 14) | | | | | | |
| Sweet-taste | fructose- | Acesulfame K | Sucralose | Stevia | Aspartame | Thaumatin |
| substance | glucose | 0.025 | 0.008 | 0.02 | 0.025 | 0.002 |
| | 6.0 | | | | | |
| Soybean | 2.0 | 2.0 | 2.0 | 2.0 | 2.0 | 2.0 |
| protein | | | | | | |
| decomposition | | | | | | |
| product | | | | | | |
| Caramel | 0.3 | 0.3 | 0.3 | 0.3 | 0.3 | 0.3 |
| Hop extract | 0.2 | 0.2 | 0.2 | 0.2 | 0.2 | 0.2 |
| Phosphoric | 0.7 | 0.7 | 0.7 | 0.7 | 0.7 | 0.7 |
| acid | | | | | | |

A sensory evaluation was made for the obtained non-fermented carbonated beer taste drink. The sensory evaluation was conducted with a nose clip attached to the nose in order to avoid influences by an aroma. For the evaluation, scores on a scale of 9 marked by 5 beer expert panelists, respectively, were averaged. The results are shown in Table 8.

TABLE 8

| | | Drink | | | |
|---|---|---|---|---|---|
| | | fulfillment and | Satisfactory | | |
| | Sweet-taste | stimulation to | sharpness | Taste like | |
| | substance | a throat | after drinking | beer | Comments |
| Control plot 9 | — | 5.2 | 4.4 | 4.8 | Sour, bitter taste |
| | | | | | remaining, washy, |
| | | | | | poor balance |
| Experimental | Glucose | 6.8 | 6.4 | 6.8 | Sweet aftertaste |
| plot 14-1 | | | | | slightly remaining, |
| | | | | | languid |
| Experimental | Fructose | 7.0 | 7.4 | 7.2 | Good balance, good |
| plot 14-2 | | | | | after-sharpness |
| Experimental | Maltose | 7.0 | 6.4 | 6.8 | Slightly gluey |
| plot 14-3 | | | | | |
| Experimental | Maltotriose | 6.8 | 4.8 | 5.0 | Gluey |
| plot 14-4 | | | | | |
| Experimental | Sucrose | 6.8 | 6.4 | 6.8 | Sweet aftertaste |
| plot 14-5 | | | | | slightly remaining |
| Experimental | Fructose-glucose | 7.2 | 7.4 | 7.4 | Good balance, good |
| plot 14-6 | | | | | after-sharpness |
| Experimental | Acesulfame K | 5.8 | 6.0 | 5.8 | Slightly washy, |
| plot 14-7 | | | | | sour taste |
| | | | | | remaining |
| Experimental | Sucralose | 6.2 | 3.4 | 4.4 | Sweet aftertaste |
| plot 14-8 | | | | | remaining, |
| | | | | | discomfort |
| Experimental | Stevia | 6.2 | 3.8 | 4.8 | Sweet aftertaste |
| plot 14-9 | | | | | remaining, |
| | | | | | discomfort |
| Experimental | Aspartame | 6.4 | 4.2 | 5.0 | Sweet aftertaste |
| plot 14-10 | | | | | remaining, |
| | | | | | discomfort |
| Experimental | Thaumatin | 5.2 | 2.8 | 3.2 | Sweet aftertaste, |
| plot 14-11 | | | | | discomfort |

Control plot 9 received low rates for “satisfactory sharpness after drinking” and “taste like beer”, had a sour taste and was considered to have a very poor balance. For experimental plots, it was confirmed that “taste like beer” was relatively improved with monosaccharides and disaccharides, and rates of “taste like beer” and so on were high particularly with fructose and fructose-glucose.

### Example 5

### Effect of Cereal-Derived Soybean Protein Decomposition Product

A dextrin of DE 14 (“Liquid Dextrin” manufactured by Matsutani Chemical Industry Co., Ltd.) as a polymeric saccharide, maltose (“MR 70” manufactured by Showa Sangyo Co., Ltd.) as a sweet-taste substance, and a soybean protein decomposition product having a molecular mass of 2 kDa, a soybean protein decomposition product having a molecular mass of 3 kDa, a soybean protein decomposition product having a molecular mass of 5 kDa, a soybean protein decomposition product having a molecular mass of 8 kDa, a corn protein decomposition product having a molecular mass of 0.5 kDa and a corn protein decomposition product having a molecular mass of 1 kDa, as cereal-derived protein decomposition products, and so on were prepared.

The formulation ingredients listed in Table 9 were mixed in amounts (g) shown by numerical values, and water was added to the resulting formulation up to a total volume of 1 L to prepare a primary raw material liquid, and the liquid was boiled for an hour. The primary raw material liquid was cooled, water was then added in an amount equal to the amount of evaporated water, and diatomaceous earth filtration and filter filtration were performed for clarification. A carbon dioxide gas was then blown into the liquid, so that the carbon dioxide gas was dissolved in a gas volume of 2.9 to obtain a non-fermented carbonated beer taste drink.

TABLE 9-1

| | Control plot | Experimental | Experimental | Experimental | Experimental |
|---|---|---|---|---|---|
| | 10 | plot 15 | plot 16 | plot 17 | plot 18 |
| Polymeric | 24 | 24 | 24 | 24 | 24 |
| saccharide | | | | | |
| (DE 14) | | | | | |
| Sweet-taste | 10 | 10 | 10 | 10 | 10 |
| substance | | | | | |
| (maltose) | | | | | |
| Caramel | 0.3 | 0.3 | 0.3 | 0.3 | 0.3 |
| Hop extract | 0.2 | 0.2 | 0.2 | 0.2 | 0.2 |
| Phosphoric acid | 0.7 | 0.7 | 0.7 | 0.7 | 0.7 |
| Cereal-derived | 0.0 | Soybean | Soybean | Soybean | Soybean |
| soybean protein | | protein | protein | protein | protein |
| decomposition | | decomposition | decomposition | decomposition | decomposition |
| product | | product | product | product | product |
| | | (average 2 | (average 3 | (average 5 | (average 8 |
| | | kDa) 2.0 | kDa) 2.0 | kDa) 2.0 | kDa) 2.0 |

TABLE 9-2

| | Experimental plot 19 | Experimental plot 20 |
|---|---|---|
| Polymeric | 24 | 24 |
| saccharide | | |
| (DE 14) | | |
| Sweet-taste | 10 | 10 |
| substance | | |
| (maltose) | | |
| Caramel | 0.3 | 0.3 |
| Hop extract | 0.2 | 0.2 |
| Phosphoric acid | 0.7 | 0.7 |
| Cereal-derived | Corn protein | Corn protein |
| soybean protein | decomposition product | decomposition product |
| decomposition | (average 0.5 kDa) 2.0 | (average 1 kDa) 2.0 |
| product | | |

A sensory evaluation was made for the obtained non-fermented carbonated beer taste drink. The sensory evaluation was conducted with a nose clip attached to the nose in order to avoid influences by an aroma. For the evaluation, scores on a scale of 9 marked by 5 beer expert panelists, respectively, were averaged. The results are shown in Table 10.

TABLE 10

| | Drink | | | |
|---|---|---|---|---|
| | fulfillment and | Satisfactory | | |
| | stimulation to a | sharpness after | | |
| | throat | drinking | Taste like beer | Comments |
| Control plot 10 | 5.0 | 6.0 | 5.4 | Sour taste, poor balance, poor |
| | | | | bubble retainability |
| Experimental | 6.8 | 7.0 | 7.0 | Good balance, drink fulfillment |
| plot 15 | | | | present |
| Experimental | 6.8 | 6.6 | 6.8 | Good balance, drink fulfillment |
| plot 16 | | | | present |
| Experimental | 7.0 | 6.4 | 6.6 | Slight soybean odor, drink |
| plot 17 | | | | fulfillment present |
| Experimental | 7.0 | 6.0 | 6.2 | Soybean odor, drink fulfillment |
| plot 18 | | | | present |
| Experimental | 5.4 | 5.8 | 5.8 | Umami taste, shrimp odor, |
| plot 19 | | | | slightly poor bubble |
| | | | | retainability |
| Experimental | 6.0 | 6.2 | 6.2 | Shrimp odor |
| plot 20 | | | | |

Control plot 10 received low rates for “drink fulfillment and stimulation to a throat” and “taste like beer”, had a sour taste and was considered to have a very poor balance. For experimental plots, it was confirmed that rates for all items were improved, and the rate for “drink fulfillment striking the throat” was improved particularly with a soybean protein of 2 kDa to 8 kDa.

1. A method for production of a non-fermented beer taste drink, comprising a step of including in drinking water 8 mg/ml or more of a polymeric saccharide and 0.008 to 100 parts by weight of a sweet-taste substance based on 100 parts by weight of the polymeric saccharide.

2. The method for production of a non-fermented beer taste drink according to claim 1, wherein the polymeric saccharide is a starch decomposition product having a DE of 5 to 24.

3. The method for production of a non-fermented beer taste drink according to claim 1, wherein the sweet-taste substance is at least one saccharide selected from the group consisting of a monosaccharide, a disaccharide and a trisaccharide.

4. The method for production of a non-fermented beer taste drink according to claim 1, wherein the method does not comprise a step of including wort or a barley extract.

5. The method for production of a non-fermented beer taste drink according to claim 1, wherein the method further comprises a step of including a cereal-derived protein decomposition product.

6. A non-fermented beer taste drink, which is produced by the method according to claim 1.

7. A non-fermented beer taste drink, which contains 8 mg/ml or more of a polymeric saccharide and 0.008 to 100 parts by weight of a sweet-taste substance based on 100 parts by weight of the polymeric saccharide.

8. The non-fermented beer taste drink according to claim 7, wherein the polymeric saccharide is a starch decomposition product having a DE of 5 to 24.

9. The non-fermented beer taste drink according to claim 7, wherein the sweet-taste substance is at least one saccharide selected from the group consisting of a monosaccharide, a disaccharide and a trisaccharide.

10. The non-fermented beer taste drink according to claim 7, wherein the drink does not contain wort or a barley extract.

11. The non-fermented beer taste drink according to claim 7, wherein the drink further contains a cereal-derived protein decomposition product.
